(19) United States
(12) Patent Application Publication
(10) Pub. No.: US 2020/0048025 A1
(43) Pub. Date: Feb. 13, 2020

(54) DISPENSER AND DISPENSING METHOD FOR LAMINATING POUCH WEB MATERIAL

(71) Applicant: ACCO BRANDS CORPORATION, Lake Zurich, IL (US)

(72) Inventors: Samuel P. Amdahl, Prospect Heights, IL (US); Adam Smith, Wilmette, IL (US); Ryan W. Pattee, Vernon Hills, IL (US)

(21) Appl. No.: 16/058,499

(22) Filed: Aug. 8, 2018

(51) Int. Cl. B65H 35/06; B32B 38/00; B32B 38/18; B65H 16/00

(52) U.S. Cl. CPC B65H 35/06; B32B 38/0004; B32B 2439/06; B65H 16/005; B32B 38/18

(57) ABSTRACT

A system for dispensing a web of two-ply laminating material includes a container in which a web of material is positioned. The web material has a first side edge along which a first ply and a second ply of the laminating material are connected. The first and second plies of the material are not connected at a second side edge of the material. An inwardly-facing surface of the first ply includes an adhesive coating. A distance between the first and second side edges defines a width of the material that is shorter than a length of the material. The opening in the container has a dimension greater than or equal to the width such that the material can be withdrawn from the container through the opening.

### BACKGROUND

The present invention relates to laminating, and more specifically to a two-ply laminating material of an adjustable length for use in laminating articles. Two-ply laminating pouches exist for at-home laminating. However, the pouches come in a designated size, and a consumer must select a specific length of a pouch for the article to be laminated. Additionally, the size range is limited and longer articles may not fit in available lamination pouches.

### SUMMARY

In one embodiment, the invention provides a system for dispensing a web of two-ply laminating material. The system includes a container having an opening and a web of two-ply laminating material positioned within the container. The web of two-ply laminating material has a first side edge along which a first ply and a second ply of the laminating material are connected together. The first ply and the second ply of the laminating material are not connected together at a second side edge of the two-ply laminating material. An inwardly-facing surface of the first ply includes an adhesive coating. A distance between the first and second side edges defines a width dimension of the web that is shorter than a length dimension of the web, and wherein the opening in the container has a dimension greater than or equal to the width dimension such that the web material can be withdrawn from the container through the opening.

In another embodiment the invention provides a method of layering a two-ply laminating material including loosely wrapping the two-ply laminating material around a mandrel, removing the mandrel from the wrapped two-ply laminating material, and folding the wrapped two-ply laminating material at least once.

Other aspects of the invention will become apparent by consideration of the detailed description and accompanying drawings.

### BRIEF DESCRIPTION OF THE DRAWINGS

FIG. 1 is a perspective view of a system for dispensing a web of two-ply laminating material embodying the present invention.

FIG. 2 is a partial perspective view of a portion of the web of two-ply laminating material.

FIGS. 3-9 illustrate the steps of assembling the system for dispensing a web of two-ply laminating material.

FIGS. 10-13 illustrate a process of folding the two-ply laminating material for placement in the container.

FIG. 14 is a perspective view of an alternative system for dispensing a web of two-ply laminating material including a core.

FIG. 15 is a perspective view of the two-ply material and the core of the system of FIG. 15.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

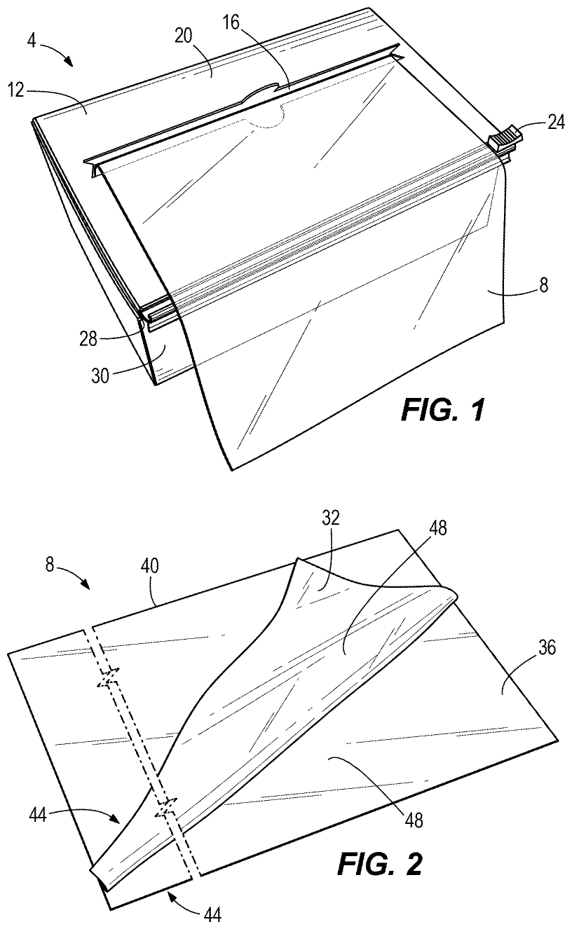

FIG. 1 is a perspective view of a system 4 for dispensing a web of two-ply laminating material 8 embodying the present invention. The example system 4 includes a web of material 8 disposed within a box or container 12. The container 12 has a slot or opening 16 on a first surface 20 (e.g., a top surface) of the container 12 through which the material 8 is dispensed. The container 12 also includes a cutting device or trimmer 24 attached on an edge 28 of a second surface 30 (e.g., a front surface) of the container 12 to cut the material 8 to a size selected based on the length of the paper product or media to be laminated. For example, the laminating material 8 may be cut to a length of approximately 11.5 inches if the paper product or media to be laminated is a standard letter sized (8.5 inch×11 inch) sheet of paper. Alternatively, if the paper product or media to be laminated is a banner that is, for example, 48 inches long, the laminating material 8 may be cut to a length of approximately 48.5 inches. A user can cut the two-ply laminating material 8 to any desired length that is less than or equal to the total length of the material 8 in or remaining in the container 12.

FIG. 2 is a partial perspective view of a portion of the web of two-ply laminating material 8. The two-ply laminating material 8 includes two plies 32, 36 of laminating material coupled or connected on one side edge 40 (e.g., a first side edge) along the length of the material 8. The two-ply laminating material 8 may be coupled by sealing (e.g., using heat and/or pressure) the edge 40 of the material 8 during a manufacturing process. That is, the edge of each of the plies 32, 36 of the two-ply laminating material 8 may be crimped and/or fused together during the manufacturing process to create the coupled edge 40 of the two-ply laminating material 8. Alternatively, the individual plies 32, 36 of the two-ply laminating material 8 may be coupled using a mechanical bond and/or an adhesive. The first ply 32 and the second ply 36 of the material 8 are not connected together at a second side edge 44 of the material 8. An inwardly-facing surface 48 of at least the first ply 32, and preferably also the second ply 36, includes an adhesive coating to facilitate lamination of the paper product or media placed between the first ply 32 and the second ply 36 of the material 8. A distance between the first and second side edges 40, 44 defines a width dimension of the web of material 8 that is shorter than a length dimension of the material 8. Stated differently, the length of the two-ply laminating material 8 is longer than the width of the material 8.

In an alternative embodiment, the two-ply laminating material 8 may be made of a single sheet of laminating material that is twice the width of the material 8, and that is folded in half to create a two-ply laminating material 8 connected along one edge. That is, one edge of the material 8 (e.g., a side edge of each of the plies) is defined by the fold line. In such embodiments, the area of the laminating material that is to be folded may be thinner than the remainder of the laminating ply to create a hinge in the laminating material to facilitate a neat, clean fold.

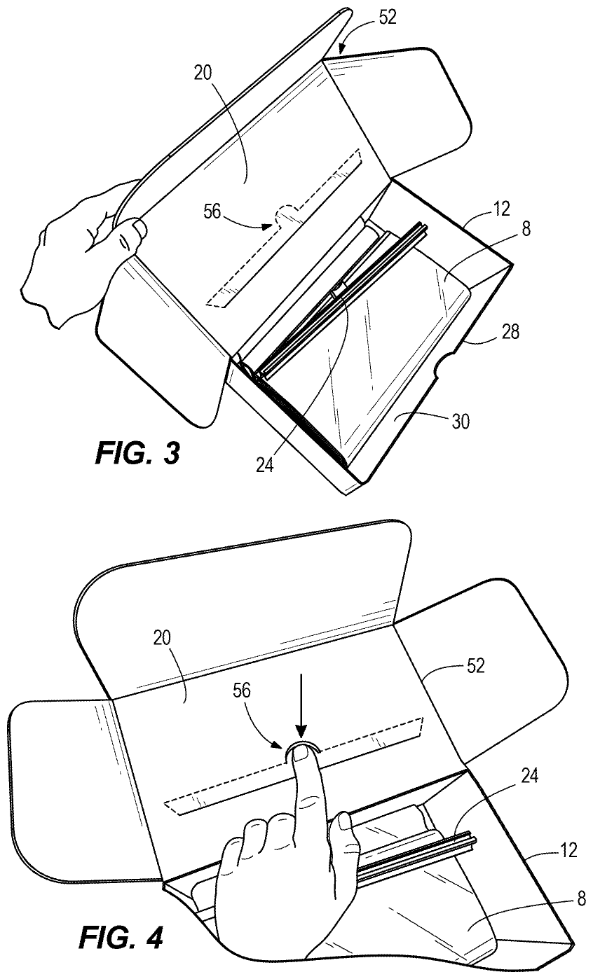

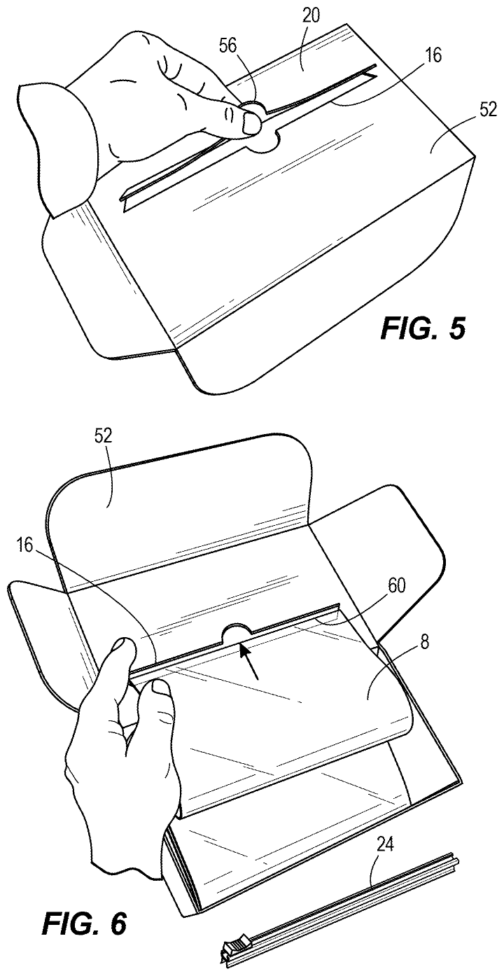

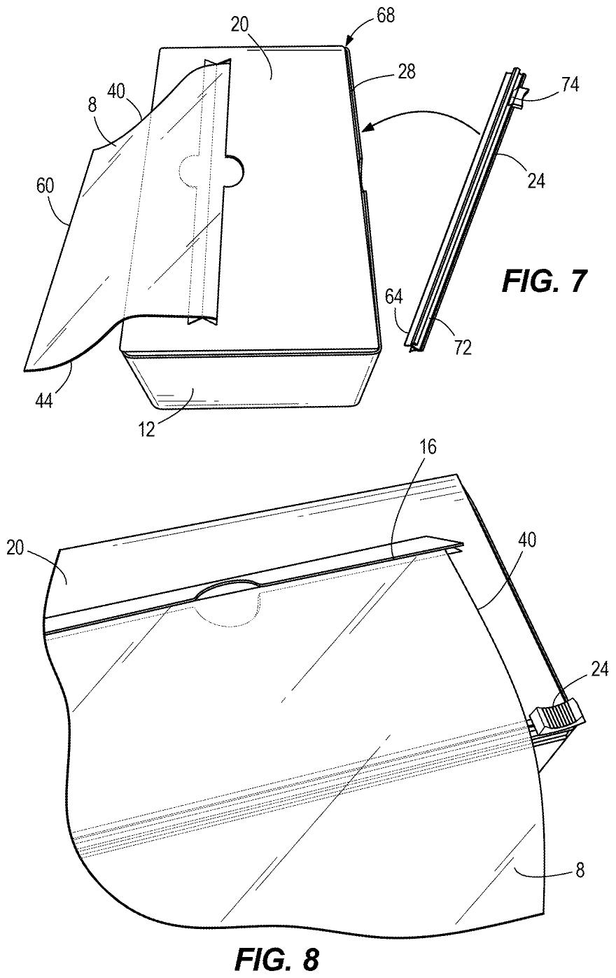

FIGS. 3-9 illustrate the steps of assembling the system 4 for dispensing a web of two-ply laminating material 8. FIG. 3 is a perspective view of the container 12 of FIG. 1 with a lid 52 open. The two-ply laminating material 8 is folded or layered within the container 12. The cutting device 24 is also stored in the container 12 until the cutting device 24 is attached to the edge 28 of the second surface 30 by a user. To set up the system 4 for dispensing a web of two-ply laminating material 8, the lid 52 is opened. A tab 56 perforated in the first surface 20 of the container 12 is then pushed outward from the inside of the container 12, as shown in FIG. 4. The container lid 52 is then closed, and the tab 56 is pulled from the outside of the closed container 12 to open or form the opening 16, which is also perforated in the first surface 20 of the container 12, as shown in FIG. 5. The opening 16 has a length greater than or equal to the width of the two-ply laminating material 8 such that the material 8 can be withdrawn from the container through the opening 16.

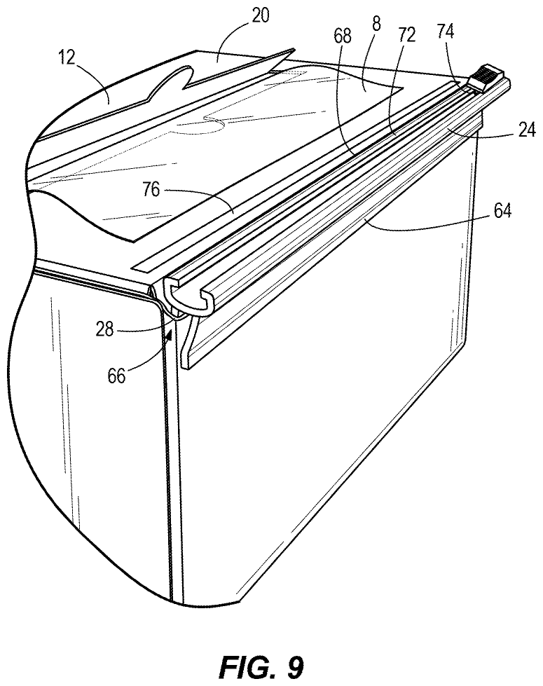

The cutting device 24 is removed from the container 12 and a first end 60 of the two-ply laminating material 8 is located. The first end 60 of the two-ply laminating material 8 is inserted into the opening 16 from the inside of the container 12, as shown in FIG. 6, so that the first end 60 extends outside of the container 12 when the lid 52 is closed. The lid 52 is then securely closed such that any side flaps attached to the lid 52 are inside the container 12 when the lid 52 is closed. The cutting device 24 is attached to an edge 28 of the second surface 30 of the container 12, as best shown in FIG. 9. In the illustrated example, an edge or side 64 of the cutting device 24 includes a set of flanges forming a channel 66 that receives the edge 28 of the second surface 30 of the container 12 such that the cutting device 12 is fastened adjacent an edge 68 of the first surface 20. A cutting surface 72 of the cutting device 24 is flush with or nearly flush with the first surface 20 of the container 12. The cutting device 24 may also be attached using an adhesive or tape to further secure the cutting device 24 to the container 12 while the cutting device 24 is in use. The adhesive may be an adhesive backing on the cutting device 24 covered by a piece of paper or similar backing that is removed from the cutting device 24 in order to attach the cutting device 24 to the container 12. Alternatively, the adhesive and backing may be positioned on the edge 28 of the container 12 where the cutting device 24 is to be positioned. The illustrated cutting device 24 includes a movable, bi-directional cutting blade 74 operative to travel (e.g., slide) along the edge 68 of the container 12 in a direction of the width of the two-ply laminating material 8 and cut the two-ply laminating material 8 to an appropriate length for the product to be laminated. The illustrated cutting device 24 is a Slide Cutter available from Shantou Yiyuan Plastics Co., Ltd., located at North 3^{rd} & 4^{th} Bldgs, Taishan Mid Road, Tailong Industrial Zone, Shantou China, 515041.

To trim the two-ply material 8, the material 8 is pulled through the opening 16 on the first surface 20 until a desired length of two-ply laminating material 8 is removed from the container 12. The material is positioned on the cutting device 24 at the point at which the material 8 is to be cut by the blade 74. Optionally, an adhesive strip 76 may be positioned on the first surface 20 adjacent the cutting device 24, and between the cutting device 24 and the opening 16, to hold the material 8 in place during and after cutting the material 8. To cut the material 8 to the desired length, the blade 74 is ideally moved from the sealed edge 40 of the material 8 to the unsealed edge 44 of the material 8 to ensure a clean cut. After trimming, the blade 74 is preferably moved back to the initial position prior to cutting a second piece of the material 8. Alternatively, since the cutting device 24 is a bi-directional cutting device 24 capable of cutting the material 8 when the blade 74 is moved in either direction, cuts can also be made in a direction from the unsealed edge 44 toward the sealed edge 40. However, when the blade 74 is moved from the unsealed edge 44 toward the sealed edge 40 for cutting, such operation may not provide as clean of a cut as cuts made in the opposite direction. In an alternative, the cutting device may take the form of a serrated member coupled to or formed integrally with an edge of the container 12. The two-ply laminating material 8 can be pulled against the serrated edge to create a force between the serrated edge and the material 8 sufficient to cut the material 8.

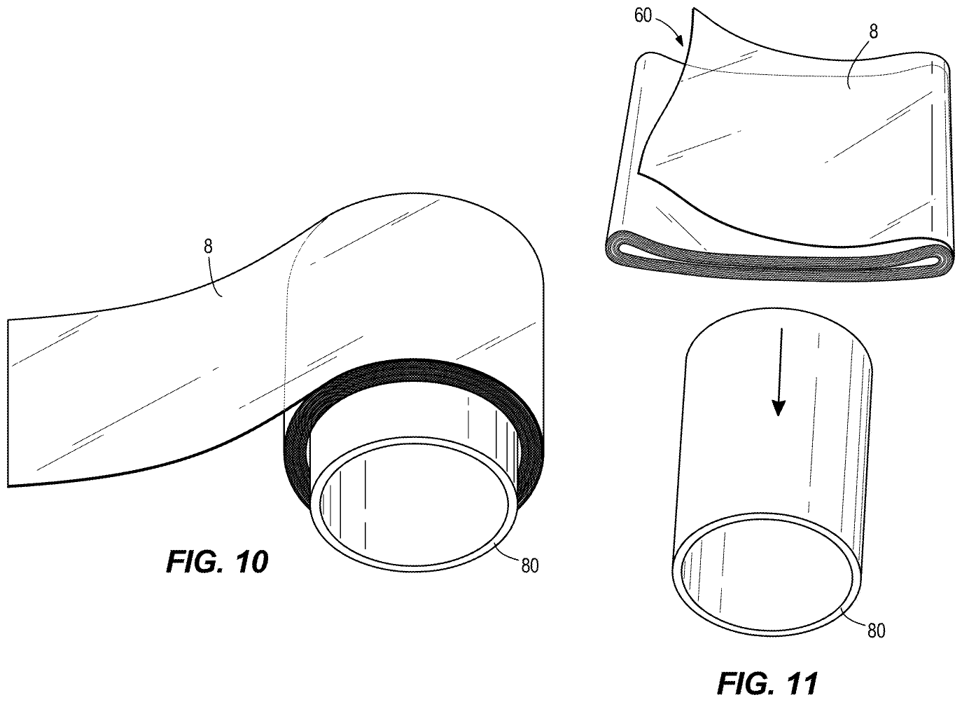

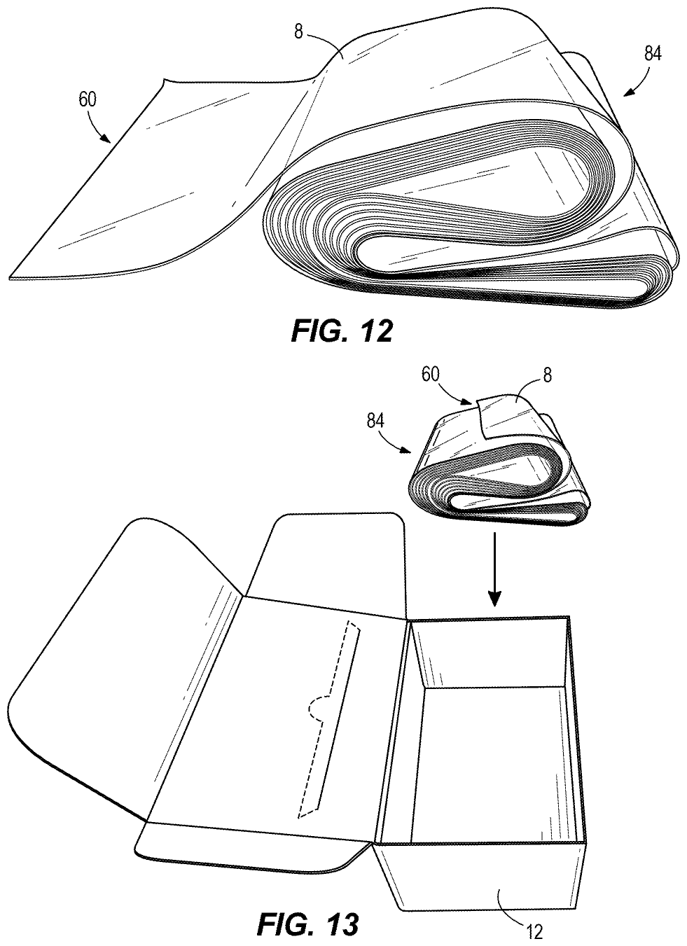

The system 4 is unique from other systems of dispensing long webs of material in that it dispenses a two-ply laminating material 8 having a single connected edge 40, and it does not include a core about which the material 8 is wound. FIGS. 10-13 illustrate a process of folding or layering the two-ply laminating material 8 for placement in the container 12 without a separate core. A designated length of the two-ply laminating material 8 is provided. The two-ply laminating material 8 is loosely wrapped around a mandrel 80, beginning at one end (e.g., the second end) of the web of the material 8, as shown in FIG. 10. The mandrel 80 has a dimension large enough to prevent any creasing, bending, wrinkling, or folding as the material 8 is wrapped around the mandrel 80. For example, if the mandrel 80 is a cylinder, the diameter of the cylinder could be about 7-8 inches. If the mandrel 80 is flat or relatively planar, the length could be about 12 inches. After the full length of the material 8 is wrapped around the mandrel 80, the mandrel 80 is removed by sliding the mandrel 80 out from between innermost layers of the wrapped two-ply laminating material 8 without unwrapping the material 8. The material 8 is then folded in half without creasing or wrinkling material 8, as shown in FIG. 12. The first end 60 of the material 8 is positioned at the top of the folded laminating material stack 84. The folded laminating material stack 84 is then placed in the container 12, as shown in FIG. 13. The first end 60 of the material 8 is easily accessible to feed through the opening 16 on the first surface 20 of the container 12. It has been found that the above-described folding technique results in smooth and wrinkle-free dispensing of the material 8 from within the container 12, thereby providing for high-quality laminated product.

In the illustrated example of FIGS. 3-13, the container 12 has a height of 4 inches, a width of 6.0625 inches, and a length of 10.375 inches. The volume of the container 12 is approximately 251.6 cubic inches. The two-ply laminating material 8 has an initial length of 75 feet and a width of 9 inches. Therefore, the initial usable lamination area of the material 8 in its two-ply state is 8,100 square inches. The ratio of the initial lamination area of the material 8 to the volume of the container 12 is approximately 32.2 square inches per cubic inch. This size of the container 12 and initial lamination area of material 8 in the illustrated example may be well-suited for home or office use. For more commercial applications, the material 8 can have a width of more than 9 inches and/or a length of more than 75 feet and the container 12 can be sized to accept the greater width.

FIG. 14 is a perspective view of an alternative system 88 for dispensing a web of two-ply laminating material 8. This system 88 includes a core 92. In this system 88, the material 8 is loosely wound around the core 92. The core 92 is a free-spinning core 92 coupled between two end plates 94. The core 92 may be coupled to the plates 94 using any suitable fastening arrangement that allows the core 92 to spin freely. For example, the plates 94 may include protrusions and the core 92 may be hollow or may have bores on each end to enable the core 92 to be coupled to the corresponding protrusions on the plates 94. The first end 60 of the two-ply laminating material 8 is fed through an opening 96 of a container 100, similar to the opening 16 on the container 12 of FIGS. 3-9. The cutting device 24 is also attached to the container 100 in a similar manner as the cutting device 24 in FIG. 9.

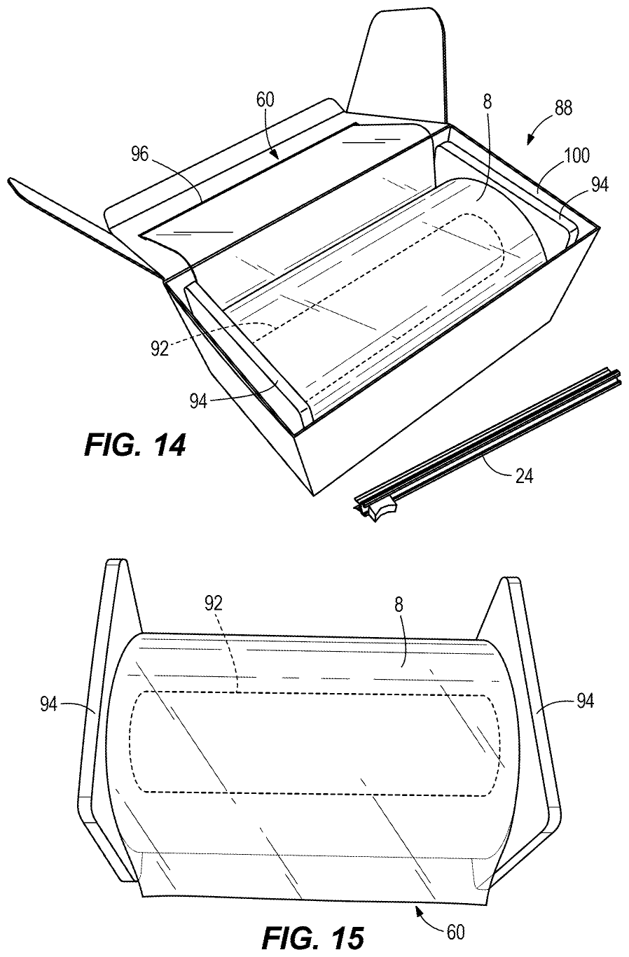

In the illustrated example of FIG. 14, the container 100 has a height of 6 inches, a width of 6.0625 inches, and a length of 10.375 inches. The volume of the container 100 is approximately 377.4 cubic inches. The two-ply laminating material 8 has a length of 100 feet and a width of 9 inches. Therefore, the initial usable lamination area of the material 8 in its two-ply state is 10,800 square inches. The ratio of the initial lamination area of the material 8 to the volume of the container 100 is approximately 28.6 square inches per cubic inch. The size of the system 88 for dispensing the web of two-ply laminating material 8 in the illustrated example of FIG. 14 may be more suited for commercial use. For larger commercial applications, the material 8 can have a width of more than 9 inches and the container 12 can be sized to accept the greater width. FIG. 15 is a perspective view of the material 8 wrapped around the core 92. In this alternative system 88, the material 8 is loosely rolled or wrapped on the core 92. The core 92 has a diameter large enough, such as 2.25 inches to 3 inches, to loosely roll the material 8 around the core 92 without creasing the material 8. Rolling the two-ply laminating material 8 around the core 92 must be done loosely because as the material 8 is rolled, each of the two plies 32, 36 in the web of material 8 is rolled around a slightly different diameter. As the outer ply (e.g., ply 32) of the web of material 8 is wrapped around the core 92, the outer ply 32 is also wrapped around the inner ply (e.g., ply 36). Thus, the diameter the outer ply 32 wrapped around the core 92 in each layer is increased by the thickness of the inner ply 36. The inner ply 36 and outer ply 32 are the same length, so tightly wrapping the two-ply laminating material 8 around the core 92 would crease or wrinkle the material 8. Loosely wrapping the material 8 prevents creasing or wrinkling and enables easy dispensing of the material 8.

Thus, the invention provides, among other things, a system for dispensing a web of two-ply laminating material that may be cut to a size selected by the user. Various features and advantages of the invention are set forth in the following claims.

What is claimed is:

1. A system for dispensing a web of two-ply laminating material, the system comprising:
a container having an opening; and
a web of two-ply laminating material positioned within the container, the web of two-ply laminating material having a first side edge along which a first ply and a second ply of the laminating material are connected together, and a second side edge along which the first ply and the second ply of the laminating material are not connected together;
wherein an inwardly-facing surface of the first ply includes an adhesive coating; and
wherein a distance between the first and second side edges defines a width dimension of the web that is shorter than a length dimension of the web, and wherein the opening in the container has a dimension greater than or equal to the width dimension such that the web material can be withdrawn from the container through the opening.

2. The system of claim 1, wherein the web of laminating material is rolled within the container.

3. The system of claim 2, wherein the web of laminating is rolled around a free-spinning core disposed within the container.

4. The system of claim 2, wherein the rolled laminating material in the container has no core.

5. The system of claim 1, wherein the web of laminating material is folded within the container.

6. The system of claim 1, wherein the container includes a cutting device operable to cut the web of laminating material.

7. The system of claim 6, wherein the cutting device includes a movable blade operable to travel along the container in a direction of the width dimension.

8. The system of claim 1, wherein the first and second plies each have a first edge, wherein the first and second plies are connected together along the respective first edges by a mechanical bond.

9. The system of claim 1, wherein the first and second plies are integrally formed as a single sheet and the first side edges are defined by a fold line.

10. The system of claim 1, wherein the length dimension of the web is at least 75 feet.

11. The system of claim 1, wherein the length dimension of the web is at least 100 feet.

12. The system of claim 1, wherein the width dimension of the web is 9 inches.

13. The system of claim 1, wherein the width dimension of the web is 12 inches.

14. The system of claim 1, wherein a ratio of an initial lamination area of the laminating material to the volume of the container is at least 28 square inches per cubic inch.

15. The system of claim 2, wherein a ratio of an initial lamination area of the laminating material to the volume of the container is at least 32 square inches per cubic inch.

16. A method of layering a two-ply laminating material comprising:
loosely wrapping the two-ply laminating material around a mandrel;
removing the mandrel from the wrapped two-ply laminating material; and
folding the wrapped two-ply laminating material at least once.

17. The method of layering the two-ply laminating material of claim 16, wherein two-ply laminating material is not creased or wrinkled when the two-ply laminating material is wrapped around the mandrel.

18. The method of layering the two-ply laminating material of claim 16, wherein removing the mandrel includes sliding the mandrel from between innermost layers of the wrapped two-ply laminating material without unwrapping the two-ply laminating material.

19. The method of layering the two-ply laminating material of claim 16, wherein folding the wrapped two-ply laminating material includes folding the wrapped two-ply laminating material in half such that an end of the two-ply laminating material is on top of the folded two-ply laminating material.

20. The method of layering the two-ply laminating material of claim 19, wherein the two-ply laminating material is folded in half without creasing the two-ply laminating material.
